(19) United States
(12) Patent Application Publication
(10) Pub. No.: US 2001/0012156 A1
(43) Pub. Date: Aug. 9, 2001

(54) DIFFRACTION SURFACES AND METHODS FOR THE MANUFACTURE THEREOF

(75) Inventors: PETER LEIGH-JONES, VERMONT (AU); BRIAN F. ALEXANDER, WANTIRNA (AU); PETER S. ATHERTON, NORTH SYDNEY (AU)

Correspondence Address: FITCH EVEN TABIN AND FLANNERY, 120 SOUTH LA SALLE STREET, SUITE 1600, CHICAGO, IL, 606033406

(73) Assignee: MIKOH TECHNOLOGY LIMITED

(21) Appl. No.: 08/793,914

(22) PCT Filed: Aug. 25, 1995
(86) PCT No.: PCT/AU95/00542

§ 371 Date: None

(30) Foreign Application Priority Data
Sep. 5, 1994 (AU) PM 7942
Sep. 26, 1994 (AU) PM 8376
Aug. 18, 1995 (AU) PN 4862

(51) Int. Cl. G02B 5/18; G02B 27/42

(52) U.S. Cl. 359/558

(57) ABSTRACT

A diffraction surface and a method of making the surface. The surface may be applied to labels and other items, to identify the original of the goods to which the label is attached. The surface can include a block grating. For example, the surface could include a plurality of blocks which adapted when illuminated will produce a recognisable image on an intercepting surface. The diffraction grating is manufactured by processing a data stream indicative of the image. Processing of the data stream includes obtaining a Fourier Transform of the data stream. Preferably, the data stream is clipped and quantised.

### TECHNICAL FIELD

The present invention relates to the production of projected images from an optically diffractive surface. These images may be confirmed either visually or by machine in order to authenticate the optical surface or for other purposes such as data storage or entertainment.

### BACKGROUND OF THE INVENTION

A current problem is the sale of counterfeit goods. Counterfeiting is often inhibited by the use of labels and trademarks. However unauthorised use of the labels and trademarks is difficult to prevent.

The above problems are discussed in International Application PCT/AU92/00252.

### OBJECT OF THE INVENTION

It is the object of the present invention to overcome or substantially ameliorate the above problems.

### SUMMARY OF THE INVENTION

There is disclosed herein A method of producing a diffraction pattern including a diffraction grating, the pattern when illuminated producing a recognisable image on a surface intercepting diffracted light resulting from the illumination, said method including the steps of:

providing a primary data stream indicative of the image;

processing the primary data to determine the configuration of said grating and therefore said pattern, with a characteristic of the processed primary data corresponding to a physical characteristic of the grating;

providing a plate having a surface to be deformed to have a configuration corresponding to said pattern;

deforming the plate surface in accordance with the processed primary data so as to produce said configuration; and wherein

a physical dimension of the grating is determined by said characteristic.

### BRIEF DESCRIPTION OF THE DRAWINGS

A preferred form of the present invention will now be described by way of example with reference to the accompanying drawings wherein:

FIG. 1 is a schematic illustration of an image and a process for producing a diffraction grating from an image;

FIG. 2 is a schematic illustration of data from which a diffraction grating may be produced;

FIG. 3 is a schematic representation of a diffraction grating;

FIG. 4 is a schematic illustration of an optical surface comprising a first region, a second region and a so-called transition region;

FIG. 5 is a schematic illustration of a close-up view of the optical surface of FIG. 4 showing the surface to be made up of cells;

FIG. 6 is a schematic illustration of the optical properties of the first and second regions of FIG. 4;

FIG. 7 is a schematic illustration of a portion of a cell of the optical surface of FIG. 4 showing the cell to be made up of so-called blocks;

FIG. 8 is a schematic illustration of a single block of FIG. 7;

FIG. 9 is a schematic illustration of an optical surface of a type which produces projected images from an incident light beam;

FIG. 10 is a schematic illustration of an example of a movement animation effect in the projected images of FIG. 9;

FIG. 11 is a schematic illustration of an example of an intensity animation effect in the projected images of FIG. 9; and

FIG. 12 is a schematic illustration of a close-up view of a preferred embodiment of a design for the optical surface illustrated in FIG. 9.

### DETAILED DESCRIPTION OF THE PREFERRED EMBODIMENT

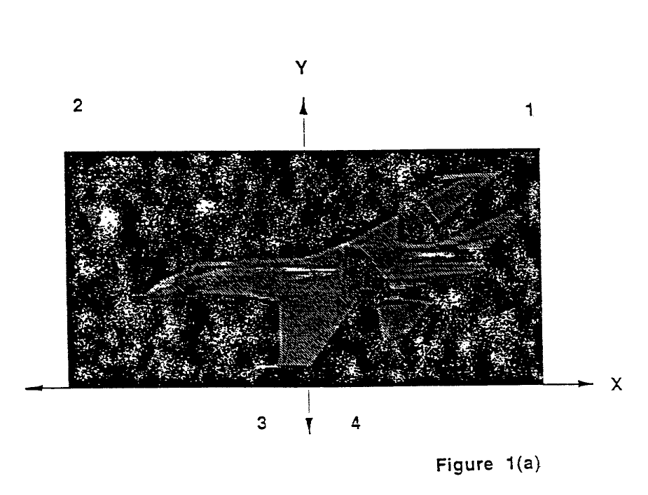

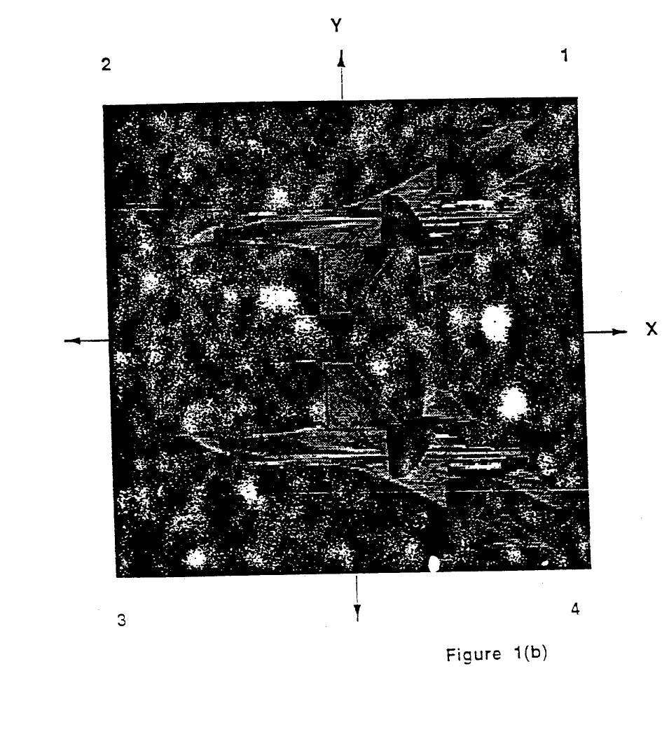

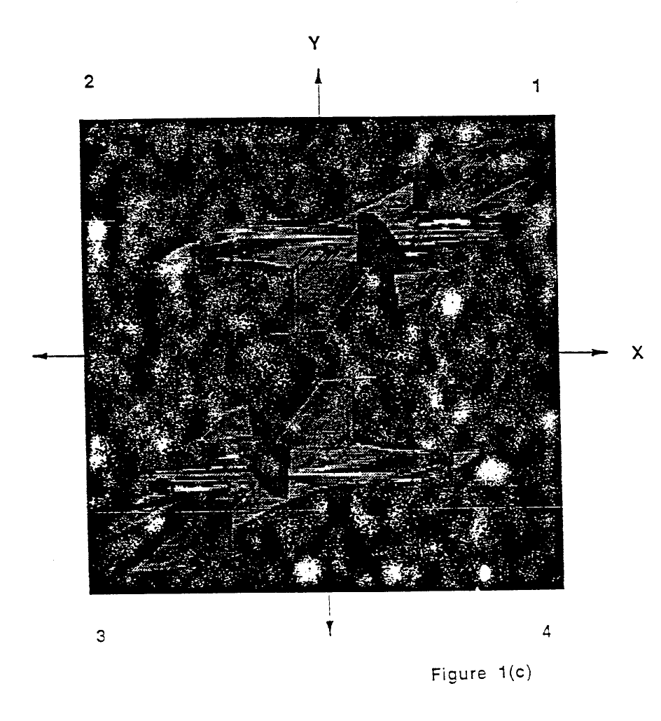

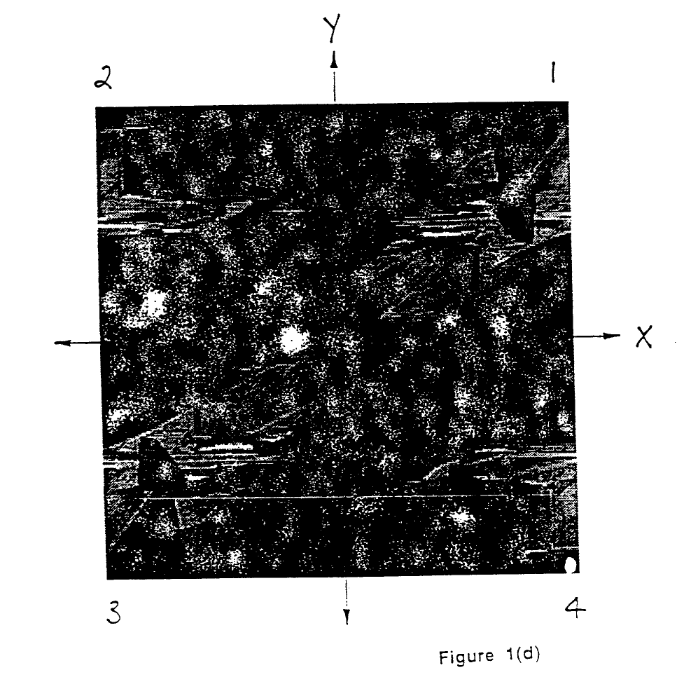

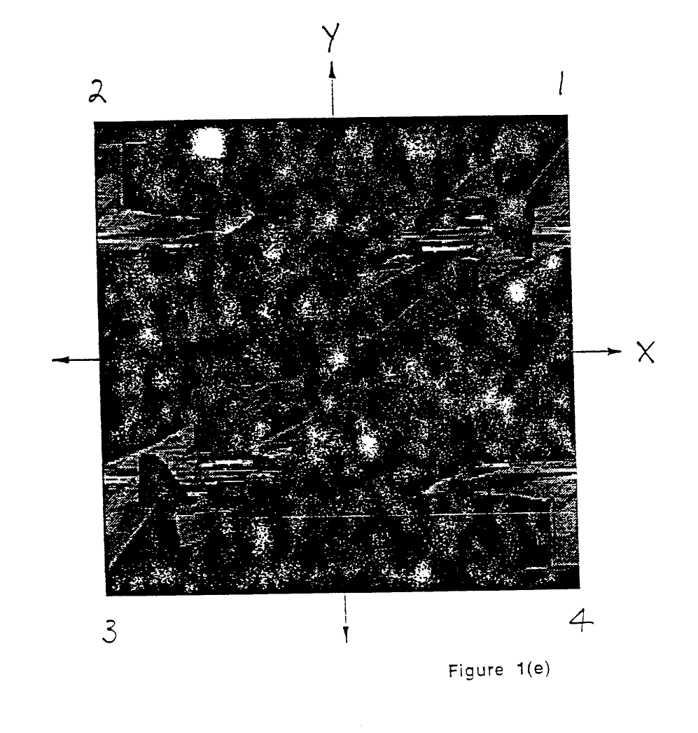

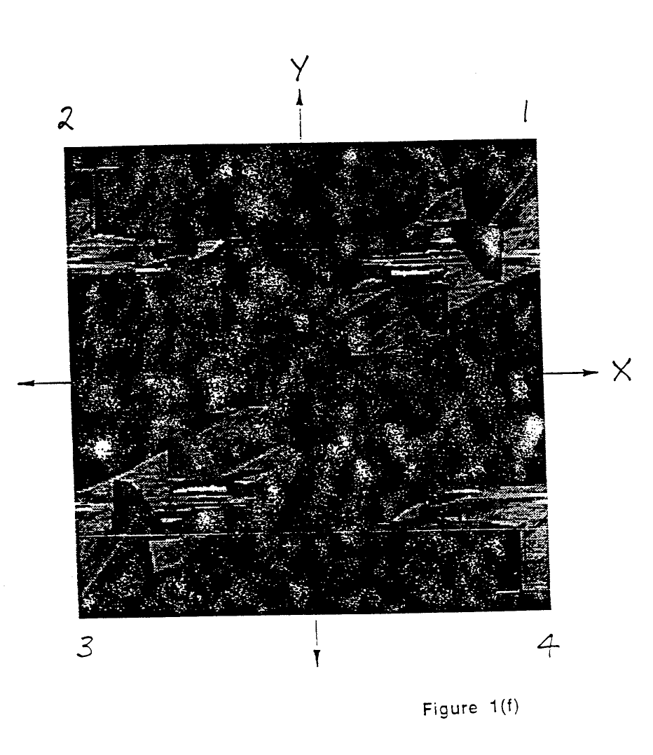

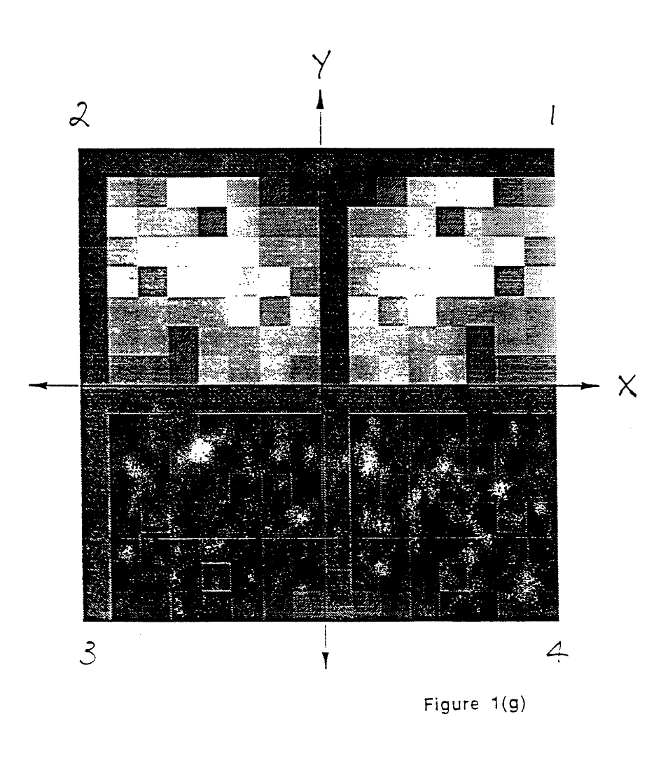

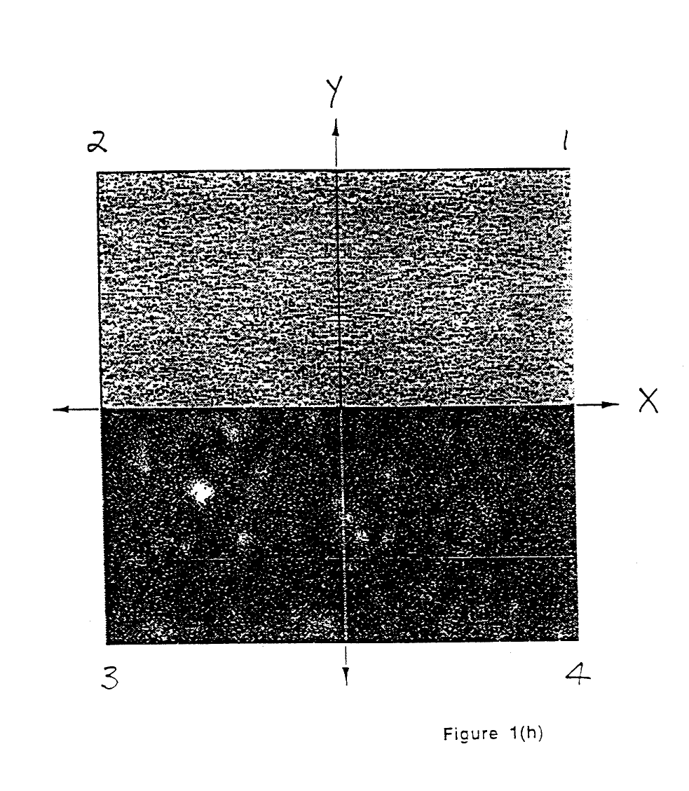

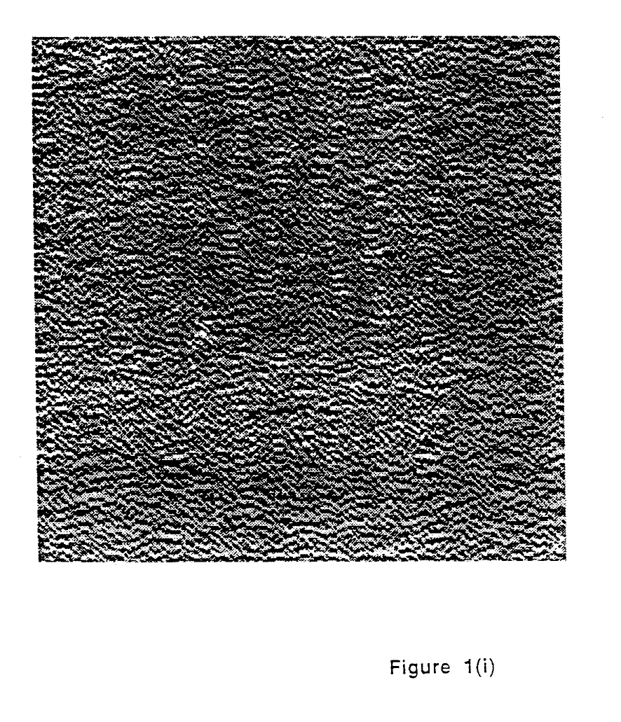

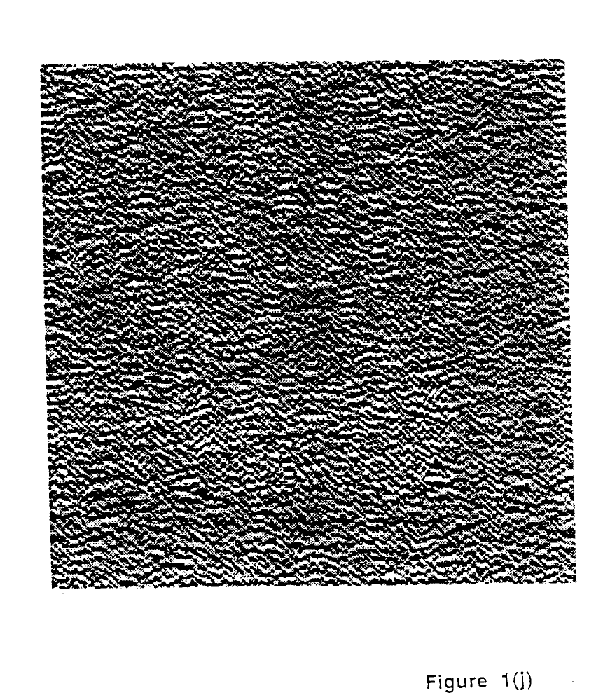

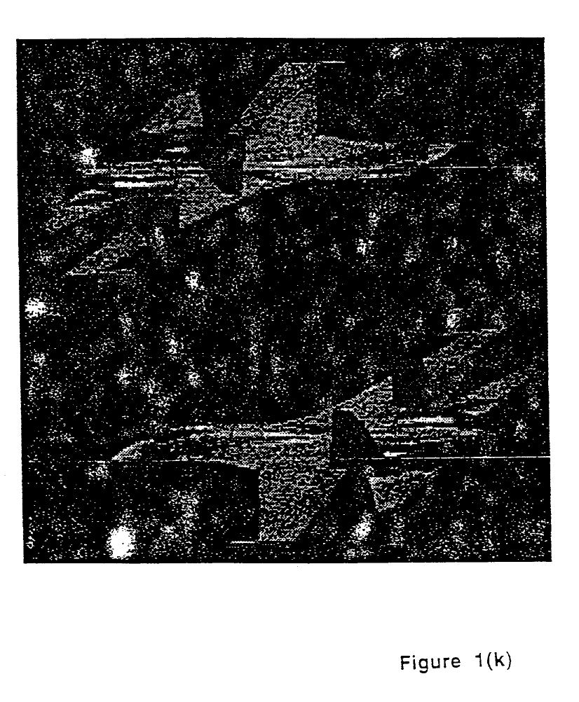

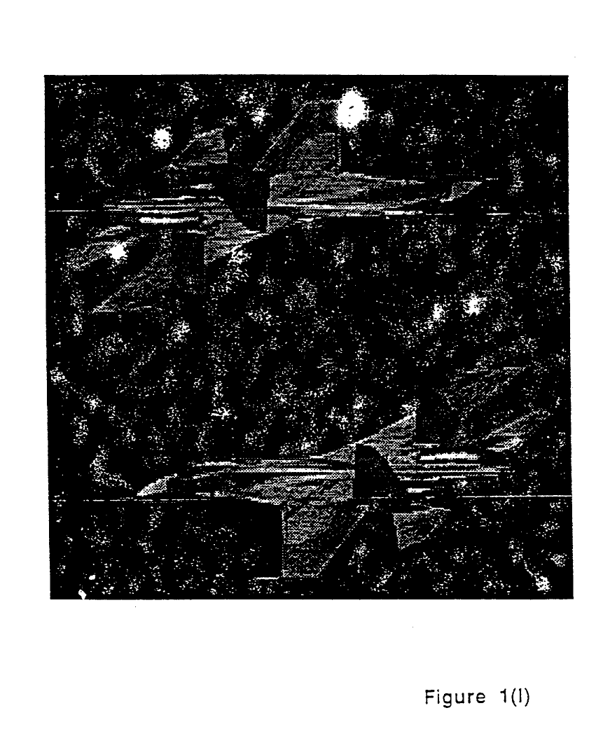

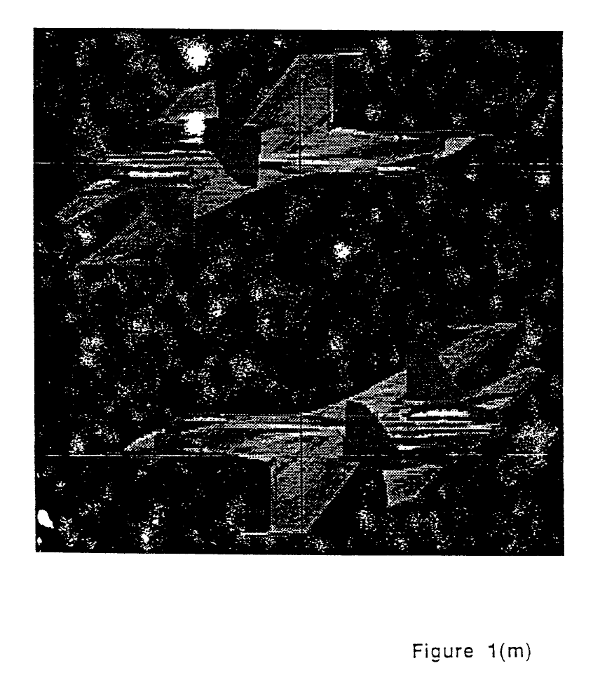

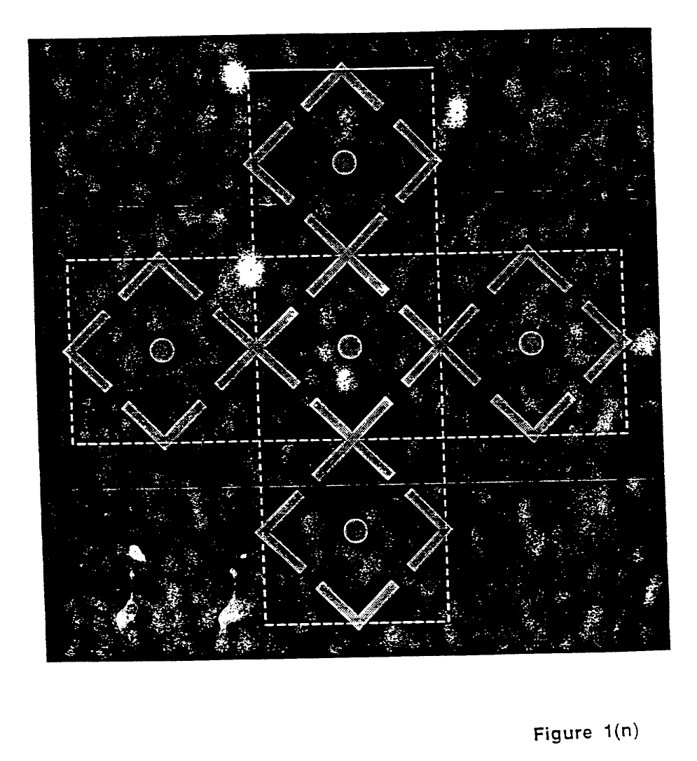

In FIG. 1(a) there is illustrated an image from which a diffraction grating will be produced so that if the grating is illuminated by a suitable light source the diffracted light will produce the image on a screen. A solid state laser is an example of a suitable light source. More particularly, the actual grating itself cannot be conveniently directly viewed for the purpose of seeing the image. The diffracted image can only be seen via appropriate illumination of the grating in which case the image will be seen on a screen receiving the diffracted light from the grating.

It should be noted that the image of FIG. 1(a) includes shaded (i.e. grey scale) regions. To manufacture the diffraction grating the image of FIG. 1(a), or a rearranged version of it, as described below, is scanned so as to produce a stream of data indicative of the image. The stream of data is obtained by dividing the image into a number of pixels or elements, and determining a data value or set of data values indicative of each pixel or element. The density of pixels in the scanning process is chosen so as to produce the required image quality in the diffracted images. For example, the image may be scanned into a 128 by 128, or 256 by 128, or 512 by 256 array of pixels. The two dimensional fast Fourier Transform can then be used to compute from the stream of data the diffraction image from which the diffraction grating is produced. In general the fast Fourier Transform of an arbitrary image consists of two non-zero parts: a so-called real part and a so-called imaginary part.

In the present invention the original input image (for example, the image of FIG. 1(a)) is processed so that the Fourier transform of the resulting processed image has negligible imaginary component—i.e. so that the Fourier transform is real-only. Preferred methods for generating the processed image are described below. The diffracted image generated by the resulting diffraction surface and projected onto an intercepting screen then consists of the original image (such as the image of FIG. 1(a)) plus a rotated version of the original image, with such an image pair (original image plus rotated image) occurring about the specular reflection (zeroth order diffracted beam) from said diffraction surface and also less strongly about the higher diffraction orders from said diffraction surface.

A difficulty with the Fourier Transform technique as used conventionally is that most of the information in the Fourier Transform is contained in a small portion of the Fourier Transform data. In the present invention this means that only a small area of the resulting diffraction pattern will be responsible for producing the image. Consequently much of the incident reading light beam will be diffracted into a conventional diffraction spot, resulting in relatively little light intensity in the diffracted images. A method of overcoming this disadvantage is to modulate the data produced by the Fourier Transform through the use of a random phase noise array as described below. In the present invention the random phase noise array must preferably be odd symmetric in two dimensions as described below.

A further improvement to the diffracted images can be made through clipping and quantising of the data provided by the fast Fourier Transform. The fast Fourier Transform data may be clipped to a percentage, for example 50%, of the peak calculated level. The resulting clipped data may then be quantised into a discrete number of levels within the clipping range. For example, the data produced by the fast Fourier Transform after clipping could be quantised into fifty, or ten discrete levels within this clipping range.

An example of a specific sequence of functions, including variations, which may be carried out in order to convert an original image into processed Fourier Transform data from which the diffraction surface can be produced is as follows. This procedure is illustrated in the sequence of illustrations of FIG. 1.

It should be noted that the layouts referred to in the present description are those which would be generated and observed on a computer screen using a computer graphics package such as Adobe Photoshop (or a similar package). It should also be appreciated that the Cartesian coordinate system, and hence the X and Y axes, used in the following descriptions are arbitrary and are included or referred to only for reasons of clarity of explanation.

1. The original or input image is positioned in a rectangular input image area and said rectangular input image area is positioned in the upper half plane (positive Y values) of a Cartesian coordinate system with the lower edge of said image area on the X axis of said Cartesian coordinate system, and the Y axis of said Cartesian coordinate system dividing said image area into two equal halves, as illustrated in FIG. 1(a). The black area in FIG. 1(a) is the input image area which includes the input image—in this case the image of an aircraft. It should be appreciated that the smaller the input image as a proportion of said input image area the brighter (i.e. higher intensity) the resulting diffracted image. This can be understood in terms of the diffracted optical power from the finished optical surface being an approximately fixed proportion of the incident optical power, so that making the diffracted images a smaller proportion of the total image plane area concentrates this approximately fixed proportion of the incident power into a smaller area, thereby increasing the diffracted image intensity.

2. The input image is digitised. The input image is divided into a Cartesian array and each element, or pixel, in the array is assigned a digitised, or quantised, value according to the values (e.g. the grey scale level) of the corresponding pixel of the input image. The array size is selected to provide the required resolution in the digitised image.

In the present preferred embodiment of the processing technique a discrete fast Fourier Transform is used to determine the diffraction grating data. The number of pixels in the X and Y directions of the Cartesian digitising array should therefore preferably be a power of 2; for example the digitising array could be a 128 by 64 element array, or a 256 by 128 element array, etc.

The original image should preferably have black (i.e. zero valued) borders of at least one pixel width all around, although this condition is not mandatory. If non-zero pixels occur on one or more borders, the imaginary component of the resultant fast Fourier Transform will tend away from zero, whereas ideally said imaginary component should be zero. However a small non-zero imaginary component in the fast Fourier Transform output may still result in a satisfactory diffraction grating.

3. The ‘quadrantised’ image is produced from the digitised input image. There are numerous variations on this quadrantising process, all of which may produce satisfactory results for all practical purposes. Two such variations are described herein. The first variation is a rigorously correct method which however leads to a minor defect in the image generated by the resulting diffraction grating, while the second variation is an approximation which removes the image defect resulting from the first variation.

### Quadrantising Method: First Variation

(i) The original digitised image is mirrored into the bottom half plane (negative Y values) of the Cartesian coordinate system, thereby producing an overall digitised image twice the size of the original digitised input image, as illustrated in FIG. 1 (b).

(ii) The bottom half plane (negative Y values) image is mirrored about the Y axis (i.e. left to right and right to left), as illustrated in FIG. 1(c).

(iii) The four Cartesian quadrants are diagonally ‘swapped’—i.e. diagonally translated into the opposite quadrants. In other words, quadrant 1 is translated into quadrant 3, quadrant 3 is translated into quadrant 1, quadrant 2 is translated into quadrant 4 and quadrant 4 is translated into quadrant 2, thus producing the image of FIG. 1(d) from the image of FIG. 1(c).

(iv) The left half plane (negative X values) of the resulting image is moved one pixel to the right (in the positive X direction), in the process discarding the right hand column (at X=−1) of the left half plane and leaving a column of zero value pixels at the left hand (maximum negative X value) border. The bottom half plane (negative Y values) is moved one pixel down (in the negative Y direction), in the process discarding the pixels in the bottom (maximum negative Y value) row and leaving a row of zero value pixels immediately below the Y axis (at Y=−1). FIG. 1(e) illustrates this method as applied to the image of FIG. 1(d). This method results in a ‘black line defect’ in the image generated from the resulting diffraction surface, as described below.

### Quadrantising Method: Second Variation

This method is an approximate method designed to remove the ‘black line defect’ generated by the first variation above.

The second variation involves steps (i), (ii) and (iii) above of the first variation, followed by the following step (iv).

(iv) The left half plane (negative X values) of the resulting image is moved one pixel to the right (in the positive X direction), in the process discarding the right hand column (at X=−1) of the left half plane and leaving a column of zero value pixels at the left hand (maximum negative X value) border. The right hand column (maximum X value) of the image is then copied into the zero filled left hand column (maximum negative X value) of the image. The bottom half plane (negative Y values) is moved one pixel down (in the negative Y direction), in the process discarding the pixels in the bottom (maximum negative Y value) row and leaving a row of zero value pixels immediately below the Y axis (at Y=−1). FIG. 1(f) illustrates the image obtained from this method as applied to the image of FIG. 1(d). This method results in a diffraction surface which does not generate the abovementioned ‘black line defect’.

4. The odd symmetric random phase noise contribution is determined. The smaller 16 by 16 array of FIG. 1(g) is used herein to illustrate the method for determining the random phase noise contribution. The X and Y Cartesian axes of FIG. 1(g) are included for ease and clarity of explanation, as in the other illustrations of FIG. 1. The method of construction of a random phase noise array, such as the 16 by 16 array of FIG. 1(g), is as follows.

(i) If the digitised input image is a 2p (in the X direction) by 2q (in the Y direction) image, a 2p⁻¹ by 2q array is first generated and positioned into quadrant 1 of a Cartesian coordinate system. The 2p⁻¹ by 2q array is allocated a random number set, with each pixel in the array being allocated a random number, except that the left hand column (at X=1) and topmost row (maximum Y value) are zero filled (i.e. have zero value). The random numbers allocated to the pixels in the array are allowed to range between 0 and 359 and represent a random phase angle to be associated with the corresponding pixels of the digitised and quadrantised input image.

(ii) The first quadrant random number array is mirrored about the Y axis into quadrant 2 of the Cartesian coordinate system, and the mirrored quadrant 2 array shifted one pixel to the right (in the positive X direction), in the process discarding the zero filled right hand column (at X=−1) and leaving a zero filled left hand (maximum negative X value) column.

(iii) The resulting top half plane (positive Y values) array is mirrored about the X axis and the resulting bottom half plane (negative Y values) array shifted one pixel down (in the negative Y direction), in the process discarding the zero filled bottom (maximum negative Y value) row and leaving a zero filled row immediately below the X axis (i.e. at Y=−1).

(iv) The bottom half plane values are negated, so that for example 54° becomes −54° and 180° becomes −180°, etc.

The simple 16 by 16 random phase array of FIG. 1(g) has been constructed as described above. FIG. 1(h) illustrates a typical 256 by 256 random phase noise array which could be used in conjunction with the quadrantised images of FIGS. 1(e) or 1(f) to generate a diffraction grating. In FIGS. 1(g) and 1(h) the phase value at each pixel is represented by a grey scale shade, with a medium grey shade representing a zero phase value, lighter grey shade representing positive phase value and darker grey shade representing negative phase value.

It should be noted that the random phase noise data may be varied by using ‘seed’ numbers to generate different random phase noise data arrays. In other words the phase noise data may be ‘seeded’ such that different phase noise data are used in different diffraction grating designs. In another variation a number of different diffraction grating designs, resulting from the use of different ‘seeded’ phase noise data arrays, may generate the same or substantially the same diffracted images. Seeding of the random phase noise data can also be used to reduce or remove any regions of optical noise which may be discernible in the diffracted image generated by a diffraction grating produced according to the present method. By varying the ‘seed’ number of the phase noise data array any optical noise in the resulting diffracted image can be varied and the image quality thereby optimised.

5. The ‘real’ and ‘imaginary’ components of the complex fast Fourier Transform (FFT) input data are generated from the quadrantised image and random phase noise data array. For each pixel in the array the following computation is performed:

Real component of FFT input=amplitude×cosine (theta)

Imaginary component of FFT input=amplitude×sine (theta)

where:

amplitude=value of quadrantised image at that pixel

theta=value of random phase noise data array at that pixel.

6. The fast Fourier Transform of the above FFT input data is computed. The objective is to achieve a wholly real FFT result since this is more readily produced in physical form as a diffraction grating. As a result of the symmetry properties of the quadrantised input image and random phase noise data array, the resulting FFT output should be real-only or approximately real-only.

In practice some non-zero imaginary component will occur in the FFT output, with the magnitude of the imaginary component depending, inter alia, on the input image quadrantisation method used. In general the abovedescribed first variation of the quadrantising method is an exact method which will generate a real-only FFT output while the abovedescribed second variation of the quadrantising method is an approximate method which may generate significantly non-zero imaginary values in the FFT output. For example, it has been found in one specific example that the first variation of the quadrantising method described above produces a maximum imaginary component value of 0.00002 for a maximum real component value of 275 (i.e. the imaginary component is zero within computational accuracy) while the second variation of the quadrantising method (which is an approximate method) described above produces a maximum imaginary component value of 0.64 for a maximum real component value of 260.

7. The basic diffraction grating data are generated via a complex to real conversion of the complex FFW output data for each pixel. For each pixel the imaginary component of the complex FFT output (which should in any case be approximately zero) is discarded and only the real part retained. FIG. 1(i) shows basic diffraction grating data obtained from the quadrantised image of FIG. 1(f) (i.e. using the second variation of the quadrantising method). Note that in FIG. 1(i) the value of the (real-only) basic diffraction grating data is indicated for each pixel as a grey scale level.

8. The basic diffraction grating data is clipped and quantised to produce the processed diffraction grating data. The basic diffraction grating data is restricted to certain extreme values and any data outside these limits is set at these extreme values. The resulting clipped data is then quantised within a specified set of quantising levels.

The clipping and quantising processes therefore ‘distort’, or introduce inaccuracies into, the basic diffraction grating data and hence in theory degrade the quality of the diffracted images generated by the resulting diffraction grating. However in practice the equipment used to reproduce the physical diffraction surface has certain resolution limits and so if the clipping and quantising processes are matched in an appropriate way to the resolution of the diffraction surface production equipment the resulting diffraction surface can actually produce diffracted images of better overall quality (taking into account both diffracted image resolution and brightness) than would be the case in the absence of the clipping and quantising processes.

The clipped and quantised data is then normalised within two specified limits, commonly between 0 and 1, so that after normalisation a value of 0.5 is approximately equivalent to a zero value in the basic diffraction grating data, bearing in mind that the basic diffraction grating data can be positive or negative and will usually be distributed approximately symmetrically about zero.

Whether normalised or not, the lower clipped and quantised value represents minimum modulation in the final diffraction surface, while the upper clipped and quantised value represents maximum modulation in the final diffraction surface. In the case of a block grating design (as described herein), minimum modulation implies no etching of a block, while maximum modulation implies maximum etching of a block.

The quantising levels, whether distributed linearly or non-linearly over the range of clipped basic diffraction grating data, usually represent uniform or linear steps in the modulation of the final diffraction grating. It should be appreciated, however, that the quantising levels may in some instances correspond in a nonlinear manner to the modulation values for the final diffraction grating. FIG. 1(j) illustrates processed diffraction grating data (after clipping and quantising) obtained from the basic diffraction grating data of FIG. 1(i). In this particular case 50 quantising levels have been used. In FIG. 1(j) the value of the processed diffraction grating data at each pixel is represented as one of 50 grey scale levels.

Typically it has been found that for an input image which is digitised into a 256 by 128 pixel array, as in the case of the input image of FIG. 1(a), good results are obtained from the final diffraction grating when the clipping and quantising are adjusted such that around 2% to 5% of the basic diffraction grating data values are clipped and the resulting clipped data are quantised into 50 quantising levels, although it should be appreciated that other variations may also produce satisfactory results.

Clipping of the basic diffraction grating data allows more of the values in the processed diffraction grating data array (i.e. the data after quantising) to be different and therefore to carry useful information. Noise on the diffracted images is minimised by adjusting the clipping and quantising of the basic diffraction grating data so the minimum number of pixels in the processed diffraction grating data array have the same data value. Excessive clipping will cause an increase in the number of pixels at the maximum or minimum (i.e. clipped) data values, while too little clipping will cause statistical bunching of the number of pixels at small data values, with few pixels at the larger values. For example, with 50 quantising levels optimal clipping will usually result in the number of identical data values in the processed diffraction grating data array not exceeding a few percent of the total number of data points. Ideally the average value of the processed diffraction grating data should be approximately half way between the maximum and minimum clipped values, so that in a block grating design (as described herein) the average etched area of the blocks (the average being taken across the grating) will be approximately 50% of an enclosed area of the mesh pattern. By way of illustration, in one specific example based on a 256 by 256 data array the peak numerical values of +698 and −738 were clipped to +150 and −150 respectively, thereby clipping approximately 2% of the total number of data points. With 50 quantising levels this resulted in the maximum number of identical values in the processed data array being around 4% of the total number of points in the array. This clipping and quantising produced clear and stable images. On the other hand in the same example it was found that clipping the peak values to +100 and −100 produced a noticeable increase in the noise on the diffracted image.

The effect of choosing different clipping and quantising schemes is illustrated in FIGS. 1(k) and 1(1). FIG. 1(k) illustrates the zeroth order diffracted images generated by a diffraction grating produced using the basic diffraction grating data of FIG. 1(i) with only 0.2% of the data values clipped and only 5 quantising levels used, while FIG. 1(l) illustrates the diffracted images generated when 4% of the data values are clipped and 50 quantising levels used. Clearly the diffracted images of FIG. 1(l) are of higher quality than those of FIG. (k).

An alternative to clipping and quantising is to use a non-linear quantising scale to allocate the basic diffraction grating data in a non-linear or non-uniform manner to the various quantising levels. The quantising levels may represent linear (i.e. uniform) or non-linear steps in the modulation of the final diffraction grating. It should be noted that striking visual effects can be generated in the diffracted images through the use of a nonlinear relationship between the quantising levels and modulation of the final diffraction grating. Use of a nonlinear scale to allocate the FFT data to the various quantising levels may be designed to have an effect analogous to clipping and quantising in that, given a maximum number of available quantising levels in the processed diffraction grating data, the non-linear scale acts to equalise the distribution of data values among these quantising levels —i.e. the non-linear quantising scale may be defined so as to minimise the number of identical data values in the processed diffraction grating data array.

A diffraction grating surface formed as described herein if illuminated by a suitable reading light beam will provide on a screen or optical sensor a projected diffracted light pattern. This diffracted pattern will include a zeroth order pattern comprising the specular reflection of the reading light beam and symmetrically disposed around this specular reflection spot two of the original input images, each of these two images being the other image rotated through 180°. For example, a diffraction grating formed from the processed diffraction grating data of FIG. 1(j) will produce at a viewing screen or optical sensor a projected zeroth order diffraction image consisting of the specular reflection spot and a pair of the original input images positioned around the specular reflection spot, as illustrated in FIG. 1(l), which is a simple variation of FIG. 1(c). (Note that in FIG. 1 (k) and 1(l) the central diffraction spot, which is centrally located between the two images, has been omitted.) In a similar manner, the higher order (first order, second order, and so on) diffraction images will consist of a diffraction spot surrounded by a pair of the original input images positioned around the higher order diffraction spot.

As described herein, there are numerous variations on the methods for ‘quadrantising’ the input image to generate a diffraction grating design. In particular two such variations—a first variation and a second variation—are described above.

The first variation is an exact or rigorously correct method but produces a so called ‘black line defect’ in the resulting diffracted image. If the input image of FIG. 1(a) is processed as described in relation to FIG. 1 and using the first variation of the quadrantising method, the resulting diffraction grating will generate a zeroth order diffraction image which has a black line, one pixel wide, running through the centre of the image alone the Y axis as illustrated in FIG. 1(m). (The central specular reflection spot is not shown in the illustration of FIG. 1(m).) In most practical situations, this black line will be visible on well adjusted apparatus for viewing such diffracted images.

The ‘black line defect’ can be removed by using the abovedescribed second variation of the quadrantising method. This second variation of the quadrantising method is an approximate method which does not provide an exactly real-only fast Fourier Transform output data array—i.e. the fast Fourier Transform output array has an imaginary component which is only approximately zero, whereas the abovedescribed first variation of the quadrantising method usually produces a fast Fourier Transform output data array which has a zero imaginary component within the accuracy of the computational method. However, a diffraction grating designed using the abovedescribed second variation of the quadrantising method will generate a zeroth order diffraction image which does not have the ‘black line defect’. FIG. 1(l) is an illustration of a zeroth order diffraction image generated by a diffraction grating designed from the input image of FIG. 1(a) and using the abovedescribed second variation of the quadrantising method. (The central specular reflection spot is not shown in the illustration of FIG. 1(l).) The image of FIG. 1(l) does not show the ‘black line defect’ and for most practical situations, where a sufficiently high resolution digitising array (such as a 256 by 128 or larger array) is used, any other discrepancies between this image and the ‘correct’ diffraction image (generated by a rigorously correct diffraction grating) will not be significant. Consequently, the abovedescribed second variation of the quadrantising method may be preferred in many practical situations.

As described above, the original rectangular input image area should ideally have black (zero value) borders of at least one pixel width all the way around the input image area. However, this condition is not mandatory, and if non-zero pixels do occur on one or more borders, the imaginary component of the resulting fast Fourier Transform output data array will tend away from zero. Ideally the imaginary component of the fast Fourier Transform output array should be zero to allow the production of an accurate physical diffraction grating. However a small non-zero imaginary component may still result in a diffraction grating design which generates satisfactory diffracted images. As also described above, a diffraction grating formed according to the method described herein will generate diffraction images around each of the diffraction orders. Hence if the input image and input image area are suitably configured, it is possible to design a diffraction grating such that the various diffraction orders, and in particular the zeroth and first diffraction orders, generated by such a diffraction grating join together to form a continuous or ‘seamless’ diffraction image. In order to achieve a continuous joining of the zeroth and first diffraction orders it may be necessary to include non-zero pixels on the borders of the input image area. FIG. 1(n) illustrates schematically the zeroth and first order diffraction images generated by such a diffraction grating for the case in which the diffraction grating is a block grating as described herein. In the case of such a block grating the zeroth order diffraction image is surrounded by four first order diffracted images. The zeroth and first order diffraction images in FIG. 1(n) are delineated by dotted rectangles which are included only for clarity of presentation. In this example the diffraction grating has been designed such that the image in each diffraction order is a central diffraction spot surrounded by four arrowheads with the zeroth and first order diffraction patterns joining at the edges of the diffraction images to form a ‘seamless’ pattern, as illustrated in FIG. 1(n). It should be appreciated that using the method described herein many diffraction grating designs can be produced having the property that the zeroth and first order diffraction images join smoothly to form a ‘seamless’ or continuous pattern.

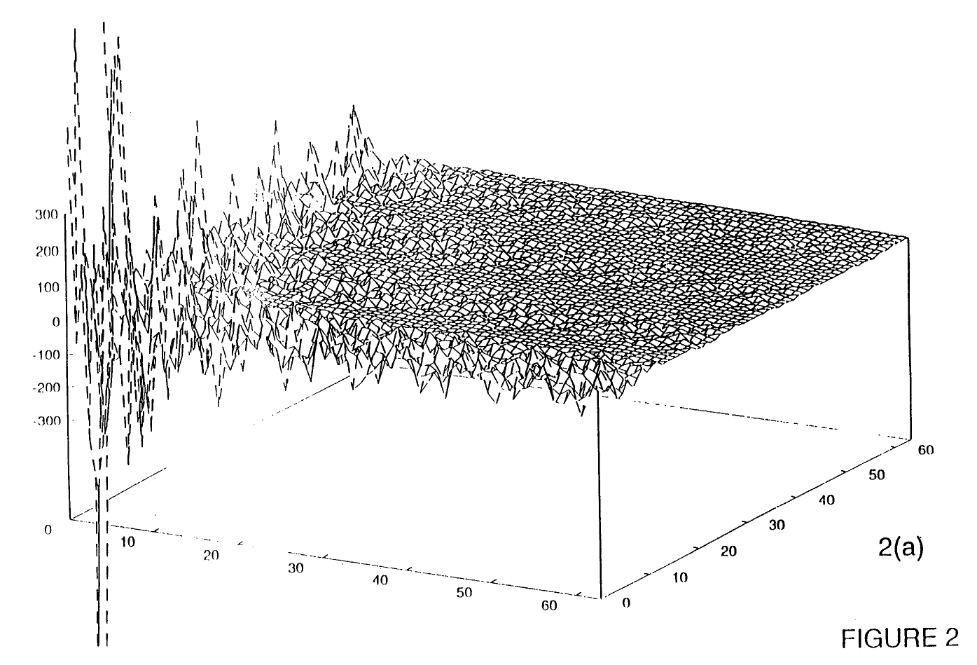

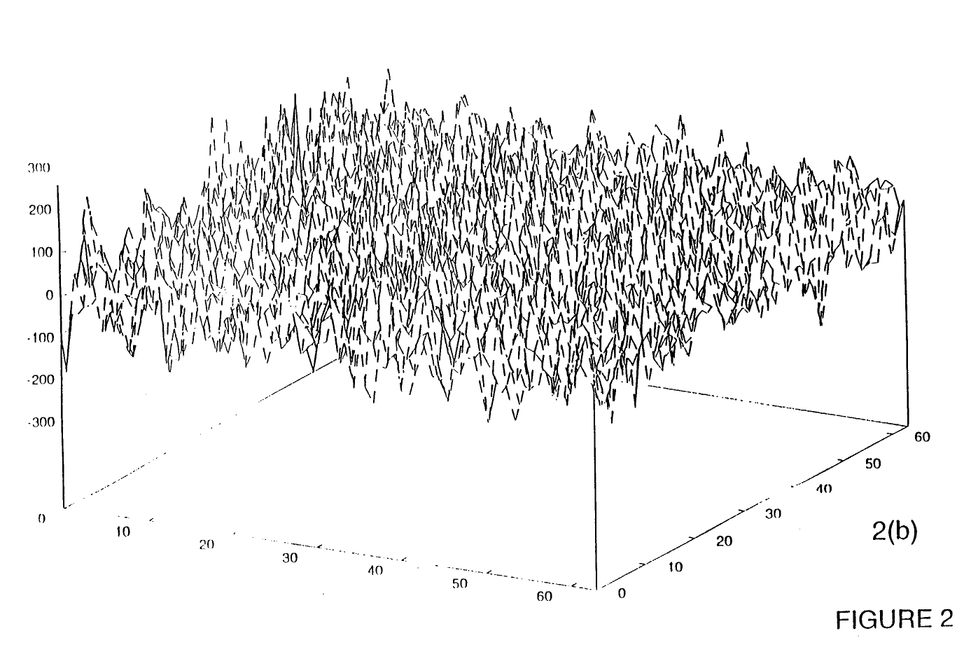

The use of a random phase noise data array, as described above, serves to spread the diffraction image information more uniformly across the diffraction grating surface, thereby increasing the intensity of the diffracted images relative to the intensity of any diffraction spots produced by the grating. FIG. 2(a) depicts schematically one quadrant of a typical diffraction grating data array derived without the use of an above described random phase noise array, while FIG. 2(b) depicts schematically the corresponding quadrant of the diffraction grating data array derived with use of a random phase noise array. (FIGS. 2(a) and 2(b) are 64 by 64 data arrays. By comparing FIGS. 2(a) and 2(b) it is apparent that the use of the random number phase sequence has overcome the above described disadvantage with regard to concentration of the diffraction image information in the resulting diffraction grating pattern, since in FIG. 2(b) the diffraction image information is not concentrated in any one portion of the grating pattern but is rather distributed across the entire grating pattern, whereas in FIG. 2(a) the diffraction image information is concentrated into a limited region of the grating pattern.

The processed diffraction grating data (derived as described above) is used to control a device capable of producing the physical diffraction grating. A preferred device for this purpose is an electron beam lithography machine. This machine etches a suitably prepared plate, made from glass or some other suitable material, according to the processed diffraction grating data. In other words the processed diffraction grating data is etched into the plate by modulating the areas, or widths, or some other property, of the pattern recorded on the plate, said modulation at a particular point being dependent on the processed diffraction grating data value at that point. In this case the processed diffraction grating data may be rearranged or reformatted in a form suitable for interpretation by the electron beam lithography machine. Other parameter values—for example, representing the physical size of the mesh in the mesh pattern of a block grating, or the number and layout of block gratings forming the overall diffractive surface—may also be input, along with the processed diffraction grating data, in order to enable production of the etched plate. It should be appreciated that the grating pattern formed in this way if illuminated by a suitable reading light beam will provide on a screen or optical sensor a zeroth order diffracted image consisting of a central specular reflection spot surrounded by a pair of the original input images, as illustrated in FIG. 1(l). (The central specular reflection spot is not shown in FIG. 1(l).) The illumination would for example be by way of a laser diode with the output beam of said laser diode suitably configured using a lens arrangement. It should be appreciated that the electron beam lithography machine may be used to record either the positive or the negative (i.e. the inverse) of the processed diffraction grating data.

As described above, any input image may be processed so as to produce a real-only or approximately real-only processed diffraction grating data array for recording on an etched plate or in some other manner.

The processed diffraction grating data may be recorded either directly on the plate or may be recorded as modulation of an underlying diffraction grating. This underlying diffraction grating could be one of a number of grating types and for example could be a simple straight line grating.

If the processed diffraction grating data is recorded directly on the plate then the amplitude of the processed data may be represented at each of a number of discrete points on the plate by the properties of an etched region at that point. In this way the resulting etched plate when viewed microscopically would consist of an array of columns or pits, where the properties of each column or pit represent the amplitude of the processed diffraction grating data at that point on the etched plate. The properties of the etched region used to represent the processed diffraction grating data may include area (parallel to the plane of the plate surface), shape (as viewed from above the surface of the plate), position, height or depth, and height or depth profile of each column or pit. In a simple implementation the area of each column or pit may represent the amplitude of the processed diffraction grating data at that point on the etched plate. In this case the columns or pits may have any cross sectional shape (i.e. the shape when viewed from above the plate), but for example will commonly be square or rectangular in shape. If the processed diffraction grating data is recorded directly on the plate in the manner described above then the diffraction image formed on appropriate illumination of the etched plate will occur around the specular reflection direction for the illuminating beam as well as around the higher diffraction orders.

A preferred embodiment of a grating produced by recording the processed diffraction grating data directly onto the etched plate is a so-called block grating. A block grating is produced by generating a mesh pattern on the plate where the mesh pattern is made up of enclosed areas such as squares, rectangles, triangles or some other shape. For example, in one preferred embodiment a block grating may include a mesh pattern of enclosed squares. Each enclosed area will include an etched region where the properties of the etched region represent the amplitude of the processed diffraction grating data at that point. The properties of the etched region used to represent the processed diffraction grating data may include the area (parallel to the plane of the plate surface), shape (as viewed from above the plate surface), position, depth, and depth profile. In a simple implementation each enclosed area in the mesh pattern may include an etched region where the area of the etched region represents the amplitude of the processed diffraction grating data at that point. In the case of such a block grating the diffracted image formed on appropriate illumination of the etched plate will occur around the specular reflection direction for the illuminating beam as well as around the higher diffraction orders resulting from the mesh pattern incorporated into the plate.

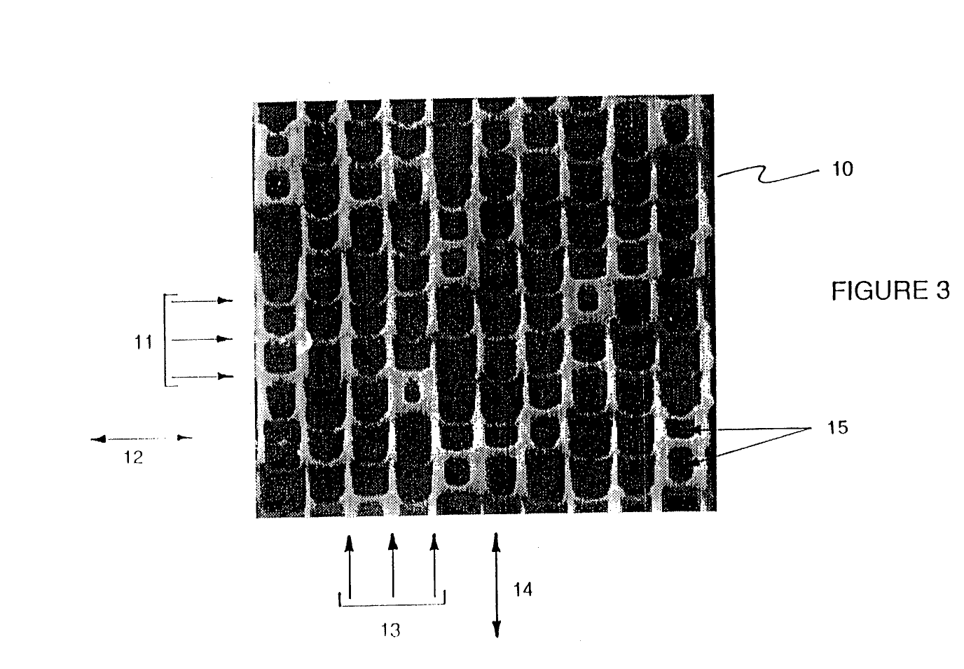

In FIG. 3 there is schematically shown a block grating 10. The grating 10 includes a series of first ridges 11 extending in the direction of the arrow 12 and a series of second ridges 13 extending in the direction of the arrow 14. Ridges 11 and 13 are generally arranged at right angles and provide a mesh pattern of enclosed squares or rectangles. The enclosed squares or rectangles include recesses 15 with the ridges 11 and 13 being displaced above the level or levels of the recesses 15. The ridges 11 and 13 in cross section are convex and either or both may have a transverse width less than the wavelength of the reading light beam. Light striking the ridges 11 and 13 is not reflected in a conventional manner since the transverse widths of the ridges 11 and 13 may be less than the wavelength of the incident light. In this design method, modulation of the block grating according to the processed diffraction grating data is achieved through modulation of the etched area within each block i.e. within each enclosed area of the mesh pattern. Hence in FIG. 3 each of the recesses 15 has been etched with an area which represents the processed diffraction grating data value at that point. For example, if the processed diffraction grating data has been normalised between 0 and 1. then a value of 0.4 indicates that the etched area in the corresponding block should be 40% of the total block area. In this block grating design type it is found empirically that adjustment of the depth of the etching process can be used to optimise the combination of brightness and resolution of the resulting diffracted images. Increasing the etching depth is found to produce brighter diffracted images although etching too deeply causes over etching at the top surface of the grating (since the walls of the etched regions are not perfectly perpendicular) which results in a loss of resolution in the resulting diffracted images. Hence there is an optimum etching depth which is determined by the properties of the etching process.

By way of illustration, the spacings between adjacent ridges in a block grating of the type illustrated in FIG. 3 which is intended for use with red laser light will typically be in the range 0.5 microns to 1 micron, while the ridges 11 and 13 will typically have widths in at least some portions of the block grating which are much less than the wavelength of the light used to view the diffracted images produced by the grating. The properties used to represent the processed diffraction grating data within each enclosed area in the mesh pattern of a block grating will typically be determined and etched to an accuracy of much less than the characteristic dimension of the block grating—for example with currently available technology the positioning accuracy of the features on the grating is 5 to 10 nanometres—i.e. around 0.5% to 1% of the side length of an enclosed square or rectangle. However, these figures are illustrative only and should not be regarded as limiting.

An alternative technique for recording the processed diffraction grating data is as modulation on an underlying grating. The underlying grating may for example be a conventional straight line diffraction grating or may instead be a grating consisting of curved lines. In this case the amplitude information in the processed Fourier Transform can be recorded as the widths of the underlying grating lines at each point on the etched plate. The images formed on illumination of the etched plate will occur about the specular reflection direction for the illuminating beam as well as around each of the diffraction orders which would normally occur for the unmodulated grating.

It should be appreciated that the present invention does not rely on differences in optical reflectivity or optical transmissivity between the etched and etched regions of the optical surface, and that in the preferred embodiments of the optical surfaces described herein the surfaces will be uniformly optically reflective or transmissive. For example in the preferred embodiment of the surface of FIG. 3 the entire optical surface, including both the ridges 11 and 13 and the recesses 15, will be uniformly optically reflective or transmissive. Thus the present invention differs from a number of the existing methods, such as so-called binary phase holograms, which rely on differences in reflectivity or transmissivity between treated and untreated regions of the surface.

The etched plate produced using the electron beam lithography machine can be used subsequently to produce a commercially, viable optically diffractive surface. This surface may for example be in the form of a thin foil. The process of producing optical foils from the etched plate preferably involves electroplating of the etched plate to produce a master shim from which embossing shims are copied. The embossing shims are used to mechanically copy the surface pattern taken from the etched plate into a layer of the foil which is then coated to provide mechanical protection for the fine embossed structure. The essential point is that the embossed layer within the foil is uniformly optically reflective or transmissive, since the embossed surface either begins with the desired optical reflection or transmission characteristic or is, after embossing, coated with a layer of uniform optical reflectivity or transmissivity. Suitable illumination of the foil results in production of the diffracted image as from the etched plate. Hence the optical surfaces in the present invention do not rely on differences in optical reflectivity or transmissivity between the etched and unetched regions of the surface. For example in the case of the preferred embodiment of FIG. 3 produced in a silver reflective foil form, the entire optical diffraction surface, including both the ridges 11 and 13 and the recesses 15, are uniformly optically reflective. It should be appreciated that other methods, such as an injection moulding method, may be used instead for producing commercially viable optical surfaces from the etched plate.

An advantage of using a block grating design, as illustrated in FIG. 3, as opposed to a modulated line grating, as described above, is that the block grating enables more quantising levels to be incorporated into the processing of the Fourier Transform data and production of the etched plate. This is because in the case of the block grating the reflective areas have two variable dimensions rather than only one in the case of the line gratings. If the electron beam lithography machine is capable of n² quantising levels in the case of a line grating the same electron beam lithography machine is capable of n² quantising levels in the case of the equivalent block grating. An increase in the number of quantising levels leads to an overall improvement in the quality of the diffracted image. Hence, for example, in the case of a block grating it may be possible to use fifty quantising levels where less than ten would be possible in the case of the equivalent line grating. Indeed a typical configuration for a block grating may involve the use of fifty quantising levels to produce clear stable diffracted images.

In the above discussed embodiment, the image is described as being projected onto a screen. In this regard it should be appreciated that light sensors could be employed to recognise the image. That is, the image could be specifically tailored (designed) to be particularly suitable for machine readability (machine recognisable). This would be particularly advantageous for high security identification and authentication applications such as credit cards, personal identification cards and product security.

The above discussed grating could be applied to any article for the purposes of determining the authenticity of the article. A grating applied to the article would be illuminated and the image projected on the screen and viewed to determine the authenticity of the article. Alternatively the image may be projected onto an optical sensor and machine recognised in order to determine the authenticity of the article. Only authentic articles would be provided with the grating, as unauthorised reproduction of the grating would be impossible without access to the above discussed method of producing the grating.

In many instances it is beneficial to scale the size of the diffraction image and the spacing of the diffraction image according to the requirements of the application. This can be done in a straightforward manner by scaling the grating pattern produced as described above. In general reducing the size of the grating pattern will produce larger and more widely spaced images while increasing the size of the grating pattern will produce smaller more closely spaced images. The relationship between the variations in grating size and the size and spacings of the images are well known according to conventional diffraction theory. A particular advantage of reducing the grating size is that the first order diffraction patterns can be removed completely. This has the advantage of concentrating all of the diffracted light into the so-called “zero order” diffracted images around the specular reflection direction for the illuminating beam, thereby making these images substantially brighter. This also has the further advantage of making the image grating detail considerably more difficult to view via the use of an optical microscope and therefore also considerably more difficult to copy or counterfeit.

Using the techniques described herein it is possible to use a very small grating pattern to produce totally acceptable and recognisable diffracted images. Typically the grating patterns would occupy a square area having a side length of 0.1 mm to 0.5 mm in size, although larger or smaller grating patterns may also be used. Also other configurations may be employed such as triangular, circular or rectangular. A diffraction surface as used to authenticate a product may be made up of a series of basic grating patterns repeated across the surface. Each of these grating patterns may be as small as 0.1 mm by 0.1 mm. If illuminated by a suitably configured and essentially monochromatic beam of light the projected diffracted image produced by such a grating pattern is clear and stable. Such a diffractive surface may be used as described herein to authenticate an object.

The optical surfaces described herein are designed to produce specified diffracted images when suitably illuminated, said images being produced around the various diffraction orders. In particular the diffracted images produced around the specular reflection direction—the zero order diffraction images—are of interest. In the preferred embodiment illustrated in FIG. 3 the optical surface is made up of a regular array of square or rectangular “cells” defined by the ridges 11 and 13, with each cell including an approximately square or rectangular recess 15, where in each cell the widths of the ridges 11 and 13 and the configuration of the recess 15 are determined as described herein.

The spacings of the ridges 11 and 13, and hence the dimensions of the “cells”, in the surface design of FIG. 3 can be specified independently of the angular sizes and angular positions of the zero order diffraction images produced by the surface of FIG. 3. In other words, a number of different surface designs of the type illustrated in FIG. 3 could be developed to produce essentially the same zero order diffraction images, with the various surface designs differing in the spacings of the ridges 11 and 13 (and also in the configurations of the recesses 15).

The angular positions of the higher diffraction orders produced by the surface design of FIG. 3 depend on the spacings of the ridges 11 and 13, with smaller spacings producing larger diffraction angles for the higher diffraction orders.

Hence optical surfaces of the type described herein can be designed such that the angular sizes and angular positions of the zero order diffraction images are specified independently of the angular positions of the higher diffraction orders produced by such surfaces.

The present optical surfaces therefore provide a degree of freedom not available from imitative optical surfaces recorded using conventional holographic techniques. In the case of a holographically recorded surface the angular positions of the various diffraction orders are specified by the configuration of the recording set-up, and it is not possible to specify the angular positions of a set of holographic projection images independently of the angular positions of the higher order images. In the case of the optical surfaces described herein the ability to specify the angular sizes and angular positions of the zero order diffraction images independently of the angular positions of the higher diffraction orders therefore provides a means to distinguish the optical surfaces described herein from imitative holographic surfaces.

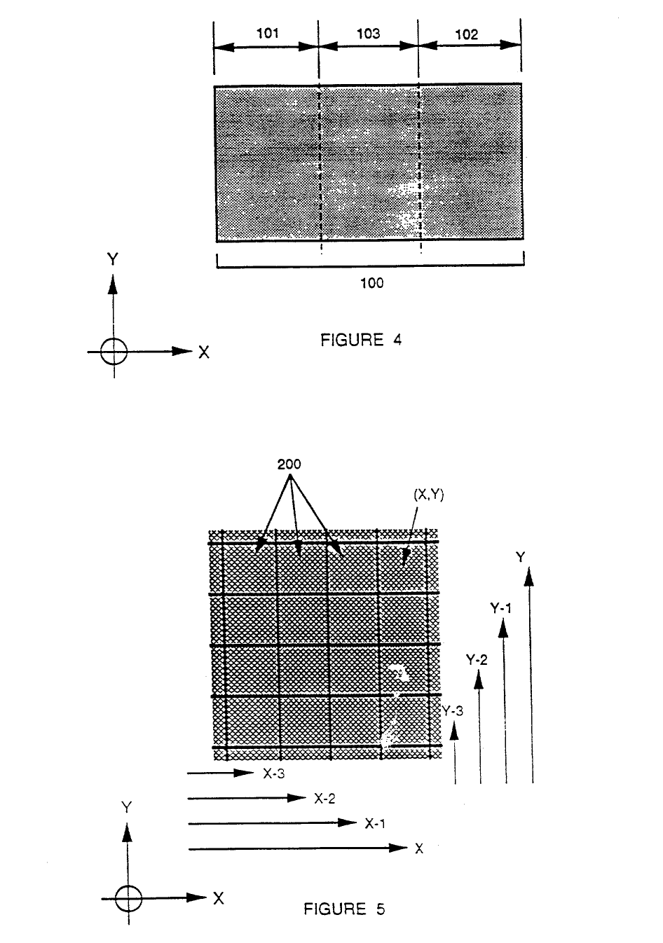

Using the techniques described herein for designing and producing diffractive optical surfaces, and in particular the so-called block grating technique as illustrated in FIG. 3, it is possible to generate diffracted images which evolve in a specified manner from one image to another as a specified incident beam of light is moved across an optical surface. FIG. 4 is a schematic illustration of an optical surface 100. The surface 100 comprises three regions: the first region 101, the second region 102 and the so-called transition region 103.

In this preferred embodiment the optical surface 100, including the regions 101. 102 and 103, is made up of basic units or cells. FIG. 5 is a schematic illustration of an area of the surface 100, showing that the surface 100 is made up of the cells 200. In the present embodiment the cells 200 in the optical surface 100 are all square and all the same size, although it should be appreciated that other configurations are possible. Each cell 200 includes an optically diffractive surface design which may preferably be a so-called block grating design as discussed herein. It should be appreciated, however, that optical surface designs other than a block grating design man, be employed in the present invention. Typically, but not necessarily, the cells 200 will have a side length in the range 0.1 to 0.5 mm.

Typically the blocks in the block grating would have a side length (width) of 0.3 to about 2.0 times the wavelength of the reading light beam. Preferably the width would be 0.5 to 1.5 times the wavelength.

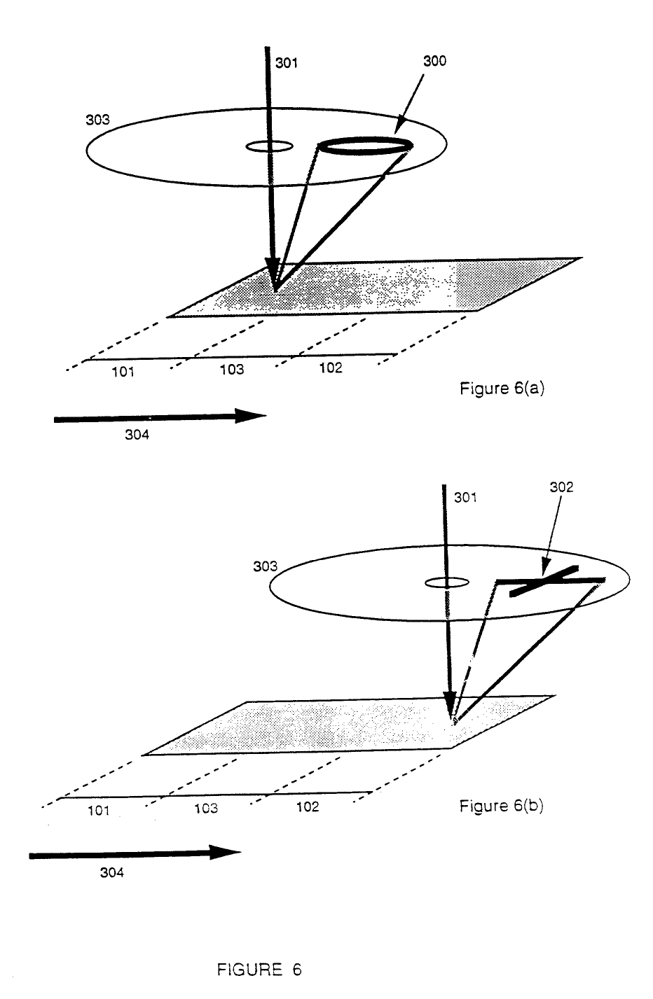

FIG. 6 illustrates schematically the optical properties of the first and second regions 101 and 102 of the optical surface 100. The first region 101 is designed to produce a first projected image 300 when illuminated by an appropriate beam of light 301, while the second region 102 is designed to produce a second projected image 302 when similarly illuminated. The projected images 300 and 302 may be projected onto a viewing screen for visual verification or onto an optical sensor for machine verification. In FIG. 6 the images 300 and 302 are shown projected onto a viewing screen 303. The images 300 and 302 may be any images and will depend on the designs of the optical surfaces 101 and 102 respectively. The light beam 301 will preferably be a specified beam of laser light. At the optical surface the beam will preferably produce a spot of light having a dimension in the direction of transformation of the optical surface—in the direction of the arrow 304 in FIG. 6—comparable with the side length of the cells 200.

As the beam of light 301 is moved continuously from the first region 101 across the transition region 103 to the second region 102, the first projected image 300 will transform into the second projected image 302. Preferably, but not necessarily, the transformation of the image 300 into the image 302 will be smooth and continuous.

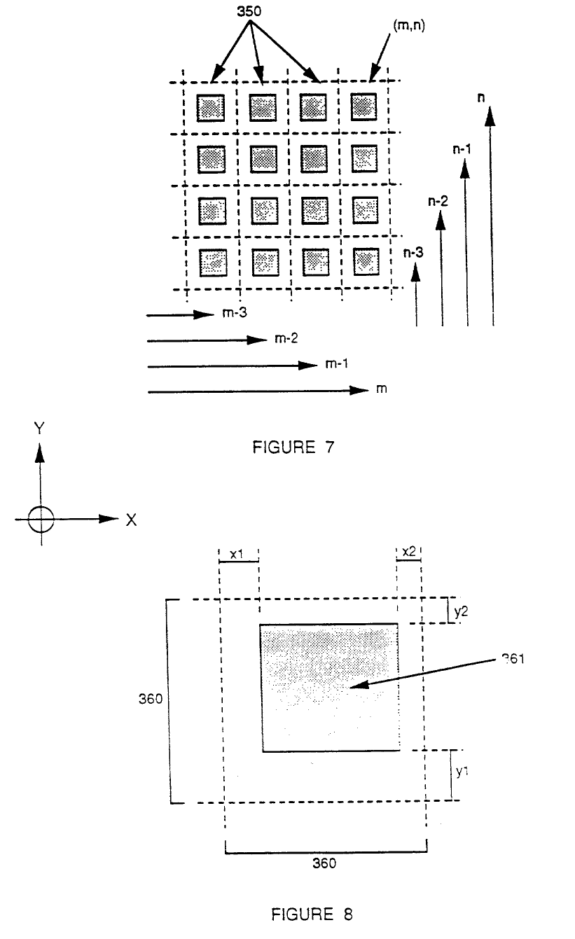

FIG. 7 illustrates schematically a close-up view of the optical surface 100, showing a portion of a cell 200. In the present preferred embodiment each cell 200 includes a so-called block grating design (as described herein), wherein the surface of each of the cells 200 is divided into a mesh pattern of enclosed areas or “blocks”, which blocks may preferably be square or rectangular in shape, or may be some other shape. Each block includes an etched region, resulting in a pit or column, where the properties (such as area, position and/or depth) of the etched region within the block are specified according to a prescribed method in order to produce the desired optical effect from the optical surface of the cell, which optical effect in the present invention is the projected image as shown in FIG. 6. For example the specification of the etched region in each block may be determined using the method described herein. The dimensions of the features within each block may be less than the wavelength of the incident light beam 301. For example in the case where each block includes an etched pit, the widths of the ridges surrounding the pit may commonly be less than the wavelength of the light beam 301.

In the preferred embodiment illustrated in FIG. 7, the block grating within each cell 200 is made up of a mesh pattern of square enclosed areas or “blocks” 350 with each block 350 having specified properties. In FIG. 7 the borders of the blocks 350 are indicated by dashed lines which are included for illustrative purposes only—in the design shown in FIG. 7 there is no physical border to each block 350. Each block 350 within a cell 200 can be specified by its position within the cell, so that for example the (m,n) block within a particular cell is the m^{th} block from the left and n^{th} block from the bottom within that cell. To use more precise terminology, each block within a cell can be specified in a Cartesian coordinate system by its (integer) x and y coordinates m and n respectively within that cell, using the lower left hand corner of the cell as the origin of the coordinate system. Hence the (m,n) block within one cell has corresponding (m,n) blocks within all other cells. It should be appreciated that other cell shapes and other block shapes could be used instead of the square cell and block shapes considered here.

In the present embodiment all cells 200 within the first region 101 of the optical surface 100 are identical, and all cells within the second region 102 are identical but different from the cells in the first region 101. The cells in region 101 are designed to produce the image 300, while the cells in region 102 are designed to produce the image 302, as illustrated in FIG. 6.

The cells 200 in the transition region 103 are designed to undergo a prescribed transformation from the design of the cells in region 101 to the design of the cells in region 102. Hence as the beam of light 301 is traversed from the first region 101 across the transition region 103 to the second region 102, the image produced from the beam of light 301 will transform from the image 300 to the image 302. The image transformation will preferably be smooth, and may be direct (i.e. the image 300 transforms directly into the image 302) or may involve passing through a number of intermediate images unlike either the image 300 or the image 302.

In the present embodiment the transformation from the cells in region 101 to the cells in region 102 can best be described with the aid of FIGS. 5 and 7. As illustrated in FIG. 5, in the present embodiment the cells 200 are square and are arranged in a square layout, although it should be appreciated that other configurations are possible. Each of the cells can be identified by a set of coordinates (X,Y) where the (X,Y) cell indicates the X^{th} cell from the left and the Y^{th} cell from the bottom, as illustrated in FIG. 5—X and Y are therefore the (integer) Cartesian coordinates of the cell.

In the transition region 103 all cells with the same X value—i.e. all cells in the same column—are identical. However, in the transition region 103 cells with different X values —i.e. cells in different columns—are different in such a wax that the design of a cell evolves across the transition region from the design of region 101 to the design of region 102.

This can be expressed more precisely as follows.

Consider a particular block (m,n). The properties of the (m,n) block will be denoted P(m,n). These properties may for example include the set of coordinates defining the “pit” or “column” within the block (m,n)—i.e. the region within the block (m,n) which has been etched in the process of recording the optical surface 100.

For instance, FIG. 8 is a schematic illustration of a typical block 360 which may be one of the blocks 350 in FIG. 7. In FIG. 8 it is assumed that the block 360 includes an etched region, or “pit”, 361, and that both the block 360 and the etched region 361 within the block 360 are square or rectangular. The block 360 may therefore be specified by the coordinates [x1,x2,y1,y2,D] which define the region of etching within the block 360, as illustrated, along with the depth of the etched region as represented by the parameter D. In such a configuration the properties P(m,n) of the (m,n) block may consist simply of the coordinates [x1,x2,y1,y2,D] for the (m,n) block. It should be appreciated, however, that in some cases additional information, such as the depth profile of the etched region, may also need to be included in specifying the properties P(m,n) of the (m,n) block.

As the X value of the cells increases in traversing the transition region 103, the properties P(m,n) of the (m,n) blocks within the cells undergo a transformation from the properties P1(m,n) in the region 101 to the properties P2(m,n) in the region 102 according to a specified function F. This can be expressed mathematically as:

F {P1(m,n)→P2(m,n)}

In other words, the function F defines the transformation of the properties of the (m,n) block across the transition region 103 from the properties P1(m,n) in the first region 101 to the properties P2(m,n) in the second region 102.

In the present embodiments all cells with the same X value are identical and so the function F is not a function of Y. In other embodiments, however, this may not be the case.

In the simplest embodiment, the function F will be a function of the X coordinate of the cell only, so that all blocks within a cell will undergo the same functional transformation from the properties of the first region 101 to the properties of the second region 102.

To take a specific example, the function F may be a linear function of X only meaning that the coordinates [x1,x2,y1,y2,D] for the (m,n) block undergo a linear transformation as X increases across the transition region 103, starting at the coordinate values for the region 101 and finishing at the coordinate values for the region 102. On the other hand, the function F may be non-linear. For example, the function F may be such that most of the variation in the coordinates [x1, x2,y1,y2,D] for the (m,n) block occurs in the middle of the transition region 103, or alternatively at either end of the transition region 103 with little variation in the middle.

In another embodiment, the function F may depend on X and also on m and n, so that different blocks (m,n) within a cell will undergo different functional transformations from the properties of the region 101 to the properties of the region 102. For example, the blocks in the top right hand corner of the cells may undergo a more strongly nonlinear transformation across the transition region 103 than the blocks in the bottom left hand corner of the cells. A dependence of the function F on the block identifiers m and n as well as on the cell column number X may be beneficial in generating a particular optical effect in transforming from the image 300 to the image 302.

The function F may either be a continuous function or may be an integer function (i.e. for integer values of the variables). However, the variables X, m and n can only take on discrete values which in the present description are integer values (0, 1, 2, 3, . . . ). Hence the function F will be “sampled” only at discrete values of X, m and n. Whether the function F depends on X only or also on m and n, it should preferably be chosen so as to produce a smooth looking transformation from the image 300 to the image 302 as the beam 301 is traversed from the region 101 across the transition region 103 to the region 102. It may be necessary to use a non-linear function F to produce a smooth and continuous looking transformation from the image 300 to the image 302. In order to generate smooth image divergence and convergence during the image transformation process, it may also be important that the function F is not strongly varying and does not include strong discontinuities.

It should be appreciated that variations are possible on the preferred embodiments of FIGS. 4 to 8.

For example, it may be important to provide a projected image which consists of both a fixed image component and a “transforming” image component as described above. In this case the optical surface 100 could be made up of basic units or cells as described above, but with each cell comprising two separate sub-cells: a first sub-cell being the same in all cells and so producing a fixed or constant projected image from anywhere on the optical surface; and a second sub-cell being designed according to the principles described herein and therefore producing an image which transforms from one specified image to another as a specified beam of light is traversed across the optical surface.

The image transformation process described herein can readily be repeated across a surface to enable multiple successive projected image transformations as a beam of light is traversed across the optical surface—i.e. image 1 transforms to image 2, which transforms to image 3, and so on.

Similarly, it should be appreciated that the image 300 and the image 302 above may actually consist of a number of images, and so the image transformation process described above may involve multiple first projected images transforming into the same or a different number of second projected images as a beam of light traverses the optical surface. (The simultaneous production of a number of images from the optical surface 100 can be achieved through appropriate design of the cells 200 as described herein). For example, the first region 101 in FIG. 7 may produce several projected images which may transform and merge into a single projected image produced by the second region 102.

Using the techniques described herein for designing and producing diffractive optical surfaces, it is possible to generate diffracted images which display movement and/or intensity animation effects as a specified incident beam of light is moved across an optical surface. FIG. 9 is a schematic illustration of an optical surface 400 designed such that a specified beam of light 401 incident on the surface 400 in a specified manner results in the production of one or more diffracted beams 402, said diffracted beams 402 producing images 403 when intercepted by the surfaces 404. The surfaces 404 may be screens designed to present said images 403 for visual inspection or may be optical sensors designed to enable machine recognition of said images 403.

The surface 400 is designed with varying surface properties which cause animation effects in one or more of the images 403 as the incident light beam 401 is moved across the surface 400. The animation effects may for example be movement effects in the images 403 or intensity animation effects in the images 403. Furthermore the animation effects may be continuous or discontinuous.

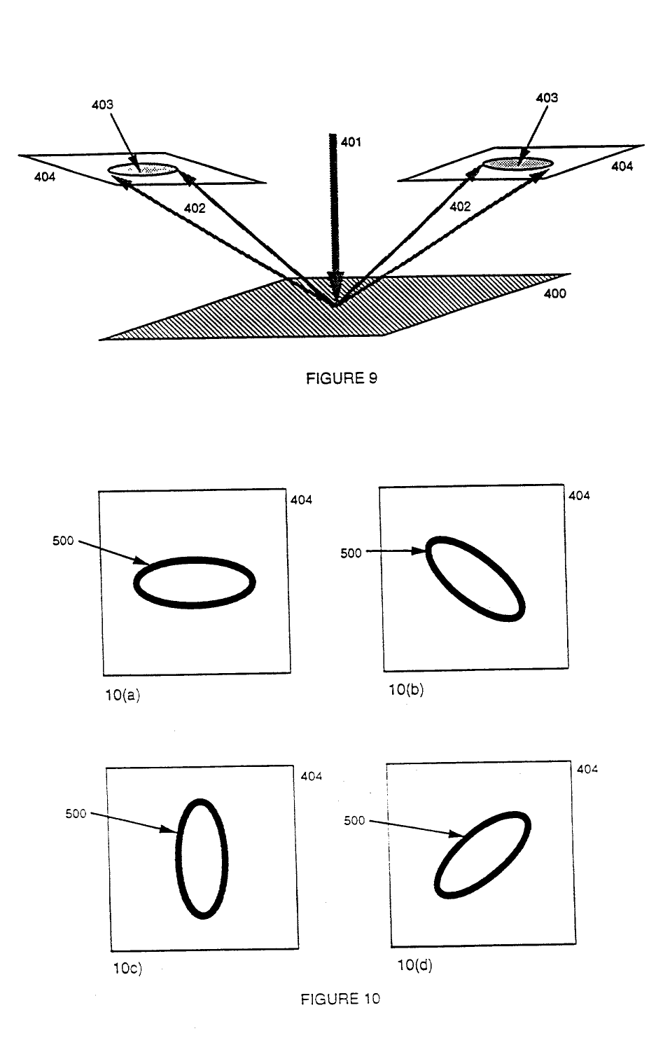

FIG. 10 illustrates an example 500 of the image 403 of FIG. 9, and a movement animation effect which may be applied to said image 500 through appropriate design of the surface 400. In this case the image 500 is an ellipse. The surface 400 may be designed such that as the light beam 401 is moved across the surface 400 the ellipse 500 rotates in either a continuous or a discontinuous manner, as illustrated schematically in FIGS. 10(a) to 10(d). The animation illustrated in the images in FIGS. 10(a) to 10(d) may repeat as the light beam 401 is moved across the surface 400. It should be appreciated that the ellipse 500 illustrated in FIG. 10 is only one example of an image which may be produced by the surface 400.

The optical surface 400 could be designed to produce any image or images 403. For example, the images 403 may be product names or logos which rotate or translate as the light beam 401 is moved across the surface 400. In another embodiment the images 403 could be images of people, animals or objects which images move or change shape as the light beam 401 is moved across the surface 400.

FIG. 11 illustrates another example 600 of the image 403 of FIG. 9, and an intensity nimation effect which may be applied to said image 600. In FIG. 11 the image 600 is the word “TEST”, although the image 600 could instead be a brand or product name. The surface 400 may be designed in such a manner that the image 600 is made up of bright letters (shown in solid shading in FIG. 11) and dim letters (shown in outline in FIG. 11), with the combination of bright and dim letters changing as the light beam 401 is moved across the surface 400. For example, FIGS. 11(a) to 11(d) illustrate a possible animation effect as the light beam 401 is moved across the surface 400, with a bright region appearing to move through the word TEST in the sequence T, E, S, T as illustrated. The intensity animation illustrated in the images in FIGS. 11(a) to 11(d) may repeat as the light beam 401 is moved across the surface 400.

It should be appreciated that more complex intensity animation effects may be employed. For example, the surface 400 may be designed such that as the beam of light 401 is moved across the surface 400, one or more “waves” of light may move through the image 403 along a linear, circular or curved path, where the diffracted image 403 could be any image.

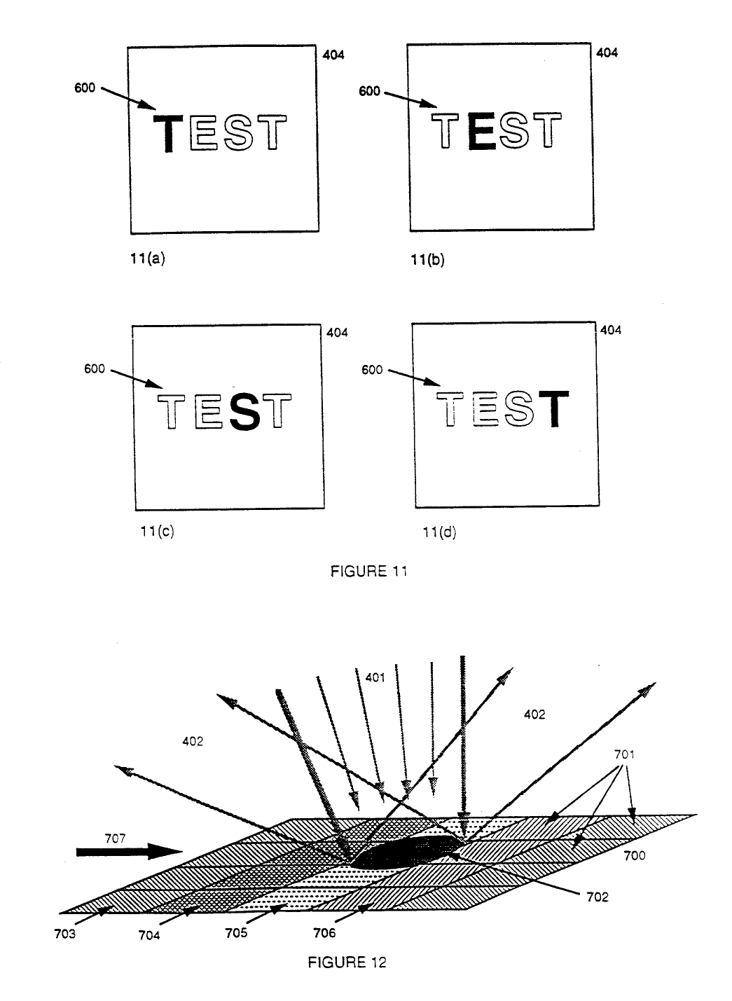

In one preferred embodiment the surface 400 may be made up of diffractive elements or cells laid out in a regular manner. FIG. 12 illustrates in close-up view a preferred embodiment 700 of the surface 400 illustrated in FIG. 9. In FIG. 12 the surface 700 is made up of cells 701 laid out in a square grid as illustrated. It should be appreciated that other cell shapes and layouts could be used instead. In the embodiment illustrated in FIG. 12 the light beam 401 is configured such that the spot of light 702 at the surface 400 has approximately the same dimensions as a cell 701. Each cell 701 is designed to produce diffracted beams 402 and diffracted images 403.

The surface 700 is designed to produce movement and/or intensit animation effects in the images 403 (as described in relation to FIGS. 10 and 11) as the light beam 401 is moved across the surface 700. In the embodiment illustrated in FIG. 12 each of the cells generates one “frame” in the animation sequence of the images 403. For example, the surface 700 may consist of four different cell types—703, 704, 705, and 706, with each of the cell types arranged in columns as illustrated. It should be appreciated that other layouts of the basic cell types 703, 704, 705 and 706 are possible and may be used in other embodiments to produce additional optical effects.

In one embodiment the surface 700 may be designed to produce the images 500 and animation effects illustrated in FIG. 10, with the cells 703 producing the image illustrated in FIG. 10(a), the cells 704 producing the image illustrated in FIG. 10(b). the cells 705 producing the image illustrated in FIG. 10(c), and the cells 706 producing the image illustrated in FIG. 10(d). Hence moving the light beam 401 across the surface in the direction of the arrow 707 will produce the images 500 and animation effects illustrated in FIG. 10. The sequence 703, 704, 705, 706 may be repeated across the surface 700.

In another embodiment the surface 700 may be designed to produce the images 600 and animation effects illustrated in FIG. 11, with the cells 703 producing the image illustrated in FIG. 11(a). the cells 704 producing the image illustrated in FIG. 11(b). the cells 705 producing the image illustrated in FIG. 11(c). and the cells 706 producing the image illustrated in FIG. 11(d). Hence moving the light beam 401 across the surface 700 in the direction of the arrow 707 will produce the images 600 and animation effects illustrated in FIG. 11. The sequence 703, 704, 705, 706 may be repeated across the surface 700.

In the preferred embodiment illustrated in FIG. 12 where the cell types 703, 704, 705 and 706 are arranged in columns, the spot of light 702, whether circular or elliptical. will preferably have a dimension perpendicular to the columns (i.e. in the direction of the arrow 707) which is comparable with or somewhat larger than the dimension of the cells in the same direction. The spot of light 702 will preferably have a dimension in the direction of the columns—i.e. perpendicular to the direction of the arrow 707—which is comparable with or larger than the dimension of the cells in the same direction. Where the spot of light 702 is strongly elliptical the long axis of the ellipse will preferably be parallel to the direction of the columns and said long axis may be significantly longer than the dimension of the cells in the same direction. In this way the different diffracted images from the various cell types will be generated in sequence to produce a smooth animation effect.

Hence the surface 700 incorporates the animation sequence in the form of a series of diffractive cells recorded across the surface, where each cell produces a “frame” in the animation sequence. By generating these “frames” in sequence, the desired animation effect is produced at the viewing screen 404. In FIG. 12 each frame is recorded as a column of cells, and the animation effect in the diffracted images is produced by movingly a specified beam of light across the surface 700 in a direction approximately perpendicular to the columns of cells, thereby generating the animation frames in sequence at the viewing screen 404. It should be appreciated, however, that other layouts of cells on the surface 700 are possible. For example, each frame in the animation sequence could be recorded as a single cell, so that a single row of cells produces an animation effect. An overall animation sequence could in this way be recorded in a matrix of cells as a series of such rows of cells. In this way the overall animation sequence could be played back by moving the spot of light 702 along one row of cells, then along the adjacent row, and so on until all cells in the matrix have been scanned. It should also be appreciated that an animation sequence could consist of as many frames as desired—for example a 30 frame sequence, or a 300 frame sequence, or a 3000 frame sequence, may be recorded in the surface 700. It should also be appreciated that the above described movement and intensity animation effects may both be incorporated into an animation sequence using the method described herein. It should be appreciated that the animation techniques described in relation to FIGS. 9, 10, 11 and 12 may also be applied to produce image transformations, or so-called ‘morphing’ effects.

The claims defining the invention are as follows:

1. A method of producing a diffraction pattern including a diffraction grating, the pattern when illuminated producing a recognisable image on a surface intercepting diffracted light resulting from the illumination, said method including the steps of:
providing a primary data stream indicative of the image;
processing the primary data to determine the configuration of said grating and therefore said pattern, with a characteristic of the processed primary data corresponding to a physical characteristic of the grating;
providing a plate having a surface to be deformed to have a configuration corresponding to said pattern;
deforming the plate surface in accordance with the processed primary data so as to produce said configuration; and wherein
a physical dimension of the grating is determined by said characteristic.

2. The method of claim 1, wherein said grating includes a plurality of surface portions from which light is diffracted to form said image, said surface portions being distributed over the plate surface so as not to be substantially concentrated.

3. The method of claim 1 or 2, wherein the step of processing the primary data includes obtaining a Fourier Transform of the primary data stream.

4. The method of claim 3, wherein said Fourier Transform is a fast Fourier Transform.

5. The method of any of claims 1 to 4, wherein data of said primary data stream is digitised.

6. The method of claim 5, wherein processing the primary data stream by a Fourier Transform includes introducing a random number phase sequence to the primary data.

7. The method of claim 5 or 6, wherein the processed primary data stream is clipped.

8. The metho of any one of claims 1 or 7, wherein said step of providing the primary data stream includes the following steps:
providing an initial image;
producing an initial data stream indicative of the image:
processing said initial data stream to provide said primary data stream and wherein said primary data stream is indicative of an image having four segments separated by Cartesian X, −Y axes, each segment being approximately half of said initial image, with the segments being arranged so that the X, Y and −X, Y segments could provide a complete initial image, and the X, −Y and −X, −Y could show a complete image, and wherein the −X, Y segment is a reproduction of the X, −Y segment rotated about the Z axis, the X, Y segment is a reproduction of the −X, −Y segment also rotated about the Z axis, and the X, −Y and −X, −Y segments if interchanged would provide said initial image.

9. The method of claim 8, wherein said initial imaze is divided into a number of pixels or cells which are used to provide said initial data stream.

10. The method of any one of claims 1 to 9 when appended to claim 3, wherein said primary data is further processed so that data indicative of the X=−1 column of pixels is discarded, and that the other −X columns are displaced in the positive X direction by one pixel, and the maximum −Y row of pixels is discarded and the remaining −Y rows displaced in the direction of the −Y axis by one pixel.

11. The method of any one of claims 1 to 10, wherein said diffraction surface is a master surface from which copies are made, and said method includes the steps of:
providing a further surface to which a copy of said master surface is to be applied:
applying the copy to said further surface; and wherein said further surface is substantially uniformly optically reflective or uniformly optically transmissive.
